(19) United States
(12) Patent Application Publication
(10) Pub. No.: US 2008/0077448 A1
(43) Pub. Date: Mar. 27, 2008

(54) Financial insurance product

(76) Inventor: Marc Diamond, Morganville, NJ (US)

Correspondence Address: HOFFMANN & BARON, LLP, 6900 JERICHO TURNPIKE, SYOSSET, NY, 11791, US

(21) Appl. No.: 11/525,314

(22) Filed: Sep. 22, 2006

(51) Int. Cl. G06Q 40/00

(52) U.S. Cl. 705/4

(57) ABSTRACT

The invention pertains to a financial product having an insurance component covering only an amount of capital at risk that exceeds a replacement cost of an asset collateralizing the capital. The product includes a payment component that provides a payment equal to at least a portion of the amount of capital at risk in excess of the replacement cost of the asset, upon loss of the asset. In the preferred embodiment the payment may be substantially equal to the amount of capital at risk in excess of the replacement cost.

### FIELD OF THE INVENTION

The present invention generally relates to asset risk management, and more particularly to a financial insurance product for insuring the value between a replacement cost of an asset and loans granted on the market value basis of the asset.

### BACKGROUND OF THE INVENTION

Insurance, or the transference of risk from one entity to another in consideration of a premium, has evolved over time into an innovative area of economics and finance. Insurance first developed in relation to risk associated with fire wherein properties were insured against destruction or loss in the case of that particular peril. Later, special coverage was developed for the risk associated with acts of vandalism and malicious mischief. Standard insurance policies were also developed that contained terms where risks outside those listed were excluded under the contract. However, over time, all-risks eventually were covered unless it was specifically excluded from the policy. Sections of contracts were then created having listings of risks not covered under the policy, which would be covered only if endorsed back to the policy by negotiated request by an endorsement. With such innovations, the insurance field has developed many variations and nuances in dealing with risks to become the complex intersection of business, finance, and economics that it is today.

One major area of risk management is in dealing with real property or real estate. A major risk often involved in transactions related to real estate is the possibility of destruction or loss of a real property or home. This risk is further exacerbated by loans made by a financial institution with the building or home as collateral and the loan based on the fair market value of the property. Currently, there are multiple instruments and policies in the art that address the risk of loss of a building or home, but do not adequately address the interplay between the loss and the full amount due on a loan.

Typically, the real estate area is classified into two major divisions, that is residential and commercial. For residential homes, a major type of insurance is Homeowner's insurance. Homeowner's Insurance protects homeowners from casualty losses or damage to the home or personal property and from liability damages to other people or property. Some types of homeowner insurance can cover a guaranteed replacement cost of the house if elected, which is the cost of physically replacing the house including construction and materials beyond the stated amount listed on the declaration page of the policy. However, in the event this guaranteed replacement cost is not elected and a loss occurs, then a gap may be created between the replacement cost and loan value of the property.

Another type of insurance is Private Mortgage Insurance (PMI). Most mortgage loans made on homes are often 70%-80% of the value of the home, due to down payments. However, if the loan to value ratio is higher than 80%, often lenders will require PMI in order to protect themselves in the event of a default. Upon default, any shortfall in the outstanding balance of the loan subsequent to foreclosure is paid by PMI insurance. Additionally, only a few insurers offer full guaranteed replacement coverage, whereas others offer only a corridor of 110% thru 125% of the value stated on the declaration page.

The difficulty is that neither homeowner's insurance, PMI nor any other insurance policies address the gap between replacement cost and outstanding loan balance in the event of a loss of the home, and furthermore such policies make up only a small piece of the market. This gap is ameliorated somewhat by the fact that mortgage loans are often only 75-80% of the appraised market value of the home. However, if a loss were to occur early on, or if the house was not appraised accurately, a large gap could be outstanding making it difficult for the homeowner to repay the loan, especially considering that individual homeowners typically have less cash reserves or economic leveraging power than commercial entities. Commercial real estate comprises larger risks and exposures due to the fact that it can involve multibillion dollar transactions with high amounts of leverage, and little or no loan to value discounts. Furthermore, the complexities of the transactions address many more factors and intricacies, with multiple parties taking on and insuring different risks.

Another type of insurance is automobile gap insurance, which is an elected optional benefit the consumer purchases at the time of sale/lease. This insurance covers the difference between the actual cash value (depreciated value of the vehicle) and the loan/lease obligation balance in the event of a loss of the asset.

Often commercial lending involves a primary insurance contract that provides a broad base coverage. On top of the primary, insurance can be provided for excess “layers”. The layers can be divided such that, e.g., the first 10 million dollars may be handled by one or more carriers, and the next 10-50 million may be assumed by other carriers, and above that still other carriers.

In addition to the primary base coverage, there are many other possible modifications of insurance contracts, such as “wrap” contracts, which are intended to “wrap” around existing base policies making up for shortfalls. One type of “wrap” contract is Difference in Conditions (DIC) contracts which fill in gaps or extend coverage outwards beyond the basic policy, on an all-risks basis, subject to certain exclusions, which are assumed to have been covered by the base policy. Furthermore there are drop-down clauses or contracts where one of the higher layers will “drop down” and pay out on a lower layer under certain conditions. Drop-down layers allow the possibility that an excess layer can “drop down” into a primary layer.

Despite the wide variety of these and other variations of insurance contracts, such insurance policies are still generally directed toward replacement cost of a building up to a designated value agreed to by the insured and the carrier rather than market value of the asset or the amount of the outstanding loan. The building's replacement cost can be determined by conducting a “Marshall Swift” report which values a building's cost for replacement.

Generally, in both commercial and residential real estate transactions, upon loss of a building or home, insurance policies seek to place the policyholder back in the position they were in immediately prior to the loss, with comparable quality materials as the original home, and without any consideration of the loan or mortgage which may be still outstanding. On the other hand, commercial lenders base mortgage loan decisions on the existing fair market value of the property, and view the transaction from the perspective of what value the property would have in case there is a default in order to recoup the loan made on commercial real estate. Lenders have therefore focused more on what occurs in the case of default and less on what occurs if there is a total loss of the property due to covered peril. As a result, there may be a significant gap between the replacement cost of the property covered by insurance, and the value owed on the loan originally made based on the market value of the property.

With rising property values, and ever increasing loans, the gap between replacement cost and outstanding loan amount increases. Also, in favorable market times, additional loans could be taken on the property thereby further increasing the gap. Therefore, on the side of lenders, as well as directors and officers with duties to shareholders, an ever increasing risk develops on the outstanding loan. In the event of loss of buildings where the gap is large, inability for owners to pay down the loan increases as well. This can lead to defaulting on the loan and large losses to the lending institutions. In the event of a fire, earthquake, terrorist attack, or other peril, where multiple buildings or other assets are lost, the financial impact could be great and widespread.

The foregoing discussion of commercial and residential real estate is exemplary, whereas loans and indebtedness are obtained with a wide variety of assets as collateral. Gaps between replacement cost and outstanding loan value can exist on all types of assets which creates uninsured risk across a broad spectrum of markets and economies.

What is needed therefore is a financial product that addresses the gap between the replacement cost and the amount of the outstanding loan and resolves the risk associated therewith.

### SUMMARY OF THE INVENTION

The invention pertains to a financial product having an insurance component covering an amount of capital at risk that exceeds a replacement cost of an asset collateralizing the capital. The product includes a payment component that provides a payment equal to at least a portion of the amount of capital at risk in excess of the replacement cost of the asset, upon loss of the asset. In the preferred embodiment the payment may be substantially equal to the amount of capital at risk in excess of the replacement cost.

Various aspects of the invention relate to covering an amount of capital at risk exceeding a replacement cost of an asset. For example, in one aspect of the invention, a financial service product includes an insurance component covering an amount of capital at risk that exceeds a replacement cost of an asset collateralizing the capital. The product includes a component wherein the asset is preferably insured by at least one separate insurance policy with a Best Rating of A+IV for the replacement cost of the asset and a payment component providing payment equal to at least a portion of the amount of capital at risk in excess of the replacement cost upon loss of the asset upon substantial payment of the replacement cost of the asset by the separate insurance policy.

The asset can be made up of a group of assets, or properties. In such an embodiment, payment can be made upon the loss of one or more assets in an amount equal to at least a portion of the amount of capital at risk in excess of the replacement cost of the one or more assets in the asset group. Preferably, the amount equal to at least a portion of the amount of capital will be an amount substantially equal to the full amount of capital at risk in excess of the replacement cost of the one or more assets.

Furthermore, the asset can be commercial or residential real estate as well as industrial equipment, retail inventory, machinery, industrial equipment, a ship, personal property, shipment of goods, cargo, or natural resources such as oil, coal, gas, or minerals. Furthermore, the asset can be intangible property such as a patent, trademark, copyright, or other intellectual property. The asset can also be a revenue stream, or licensing rights, or rights to revenue stream from rental properties. The aforementioned assets are all exemplary and not limiting for the current invention.

In yet another aspect, a method of insuring the value between a replacement cost of an asset and loans given on the basis of the asset comprises identifying an asset that collateralizes the capital at risk as well as insuring only that amount of capital at risk that exceeds a predefined replacement cost of the asset. Other embodiments may include requiring that the asset be insured under a separate insurance policy covering at least the predefined replacement cost. Still further embodiments may include a step of making payment upon a claim only after substantial payment of the predefined replacement cost of the asset by the separate insurance policy.

Additional features and advantages of the present invention will be readily apparent from the following detailed description, the accompanying drawings and the claims.

### BRIEF DESCRIPTION OF THE DRAWINGS

FIG. 1 is a graphical depiction of a gap according to the present invention.

FIG. 2 is a block diagram of a method of insuring capital at risk according to the present invention.

Like reference symbols in the various drawings indicate like elements.

### DETAILED DESCRIPTION OF THE PREFERRED EMBODIMENT

The present invention relates to a financial insurance product and techniques for insuring the portion of an outstanding loan collateralized by an asset that is in excess of the replacement cost of the asset in the event of a total loss of the asset. Preferably, the asset is separately insured by an underlying insurance policy for the replacement cost of the asset.

The product and techniques can be used for any asset where a loan is obtained on the asset. Preferably, the asset is insured based on a primary policy for the replacement cost of the asset, and where the loan amount exceeds the replacement cost. The product insures the difference between the replacement cost of an asset and the full value of the outstanding loan on the insured asset. As used herein, the term “replacement cost” is the amount of money required to replace an item or property to a pre-loss condition without a deduction for depreciation. Activation of the instrument by payment of the premium enables recovery from the insurer and allows the outstanding loan to be paid off. Preferably, a premium is paid for the insurance product that is determined by standard actuarial practices.

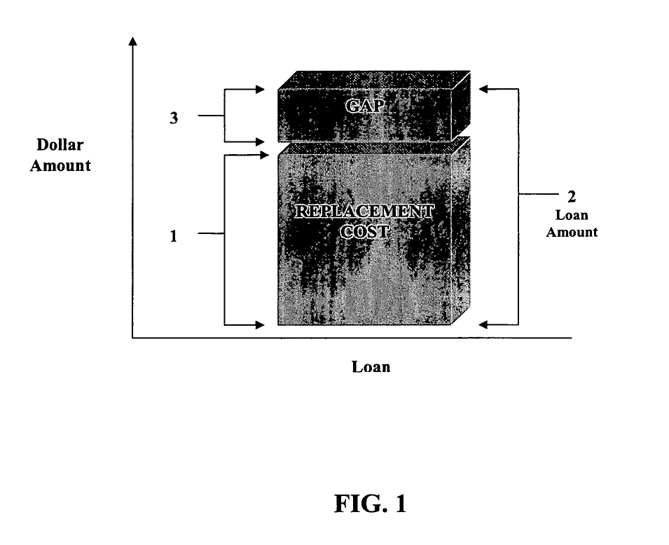

Referring now to FIG. 1, a graphical depiction of a gap associated with an asset is shown. As shown in the FIG. 1 example, the replacement cost 1 is a value associated with physically replacing the asset. For example, in relation to a building, the replacement cost 1 is the cost of physically replacing the building with a new building, including construction and materials. Preferably, the replacement cost is insured by a primary insurance product and can often be determined accurately using a Marshall Swift Report. Preferably, providers of the primary insurance product have a Best Rating of A+IV

The loan amount 2 is the total loan originally collateralized by the asset based on its fair market value. The gap 3 is the difference between the outstanding loan amount for the asset and the replacement value of the asset. Hence, the gap 3 is the loan amount still owed to one or more lenders after the replacement cost of the asset has been paid by the primary insurer.

Preferably, the financial product is not a part of the primary layer insurance contract and may be independent of and separate from the underlying negotiated contract. As an additional separate specialized instrument, the financial insurance product is in excess of the primary and all excess layers and not considered a broadening of the underlying insurance product. Preferably, the instrument does not include any drop down clauses. Additionally, because the product is separate from the underlying policy, the underlying product may permit or grant permission to purchase excess coverage.

The product is based on a “follow-form” type policy that follows the terms of the primary underlying policy, including its exclusions as well as its coverage. For example, if the underlying policy terms include or exclude certain losses from conditions such as mold, lead, terrorism, demolition, then so would the product of the present invention. Although separate and independent from the primary policy, the insurance product in an embodiment of a follow-form policy can follow the terms of the primary policy. This, may therefore reduce negotiation costs as well as reduce complexity.

In one preferred embodiment, the product provides payment only after the underlying layers and policies have been fully exhausted in payment of the replacement cost of an asset and the lender still is owed an outstanding amount of the loan. Preferably, payment is not activated if the loan is defaulted prior to the loss and activation of the underlying policy.

In certain situations, the ability to restore an asset to its pre-loss condition may be limited by applicable laws or regulations. For example, in a “down zoning” situation where there is a loss to real property and current zoning rules do not permit the property to be rebuilt to the same size or specification (i.e., prior to the loss the property included five floors and after the loss the zoning board only permits three story structures), the replacement cost of the asset is reduced. In an alternative embodiment of the present invention, the gap between this reduced replacement cost and the outstanding capital at risk is covered.

According to one preferred embodiment, the underlying base coverage reflects replacement cost of the asset, and does not provide only partial coverage. In this preferred embodiment, the assets are insured to one hundred percent of the replacement cost value. This is due to the fact that the product insures the excess loan amount above the replacement cost. It is preferable that the basic insurance carrier have a strong rating such that it reasonably can be expected to pay on its policy in the event of a loss. Furthermore, it is preferable to require the application for the instrument to include a financial statement disclosure as well as grant permission to obtain a credit and/or financial condition report such as a Dun & Bradstreet report and a Marshall Swift real estate property report of each asset to be insured. In one preferred embodiment, the instrument is offered on a five year contract basis that is renewable if all underwriting criteria and warranties are met. Other embodiments may provide for other time periods. The premium can be determined by standard actuarial practices as known in the art. In a preferred embodiment, the premium may be paid in a first upfront installment. In other embodiments, payment may be structured in alternative ways.

Furthermore, if the outstanding loan balance collateralized by the asset decreases during the policy period, the maximum amount paid by the product remains the outstanding loan in excess of the replacement cost. Therefore, as the principal is paid or loan is reduced, the amount the instrument pays out, based on the gap, or the outstanding excess loan is reduced as well. Therefore, the insurance provider's exposure to risk can be reduced as the loan is repaid.

Alternatively, after initial signing of the loan, if more loans are later taken based on the home or building or asset as collateral, some embodiments may provide for the instrument to include in its terms coverage for that new increased gap or outstanding loan amount in excess of the replacement cost. Furthermore, the initial or later loan amounts may be comprised of multiple loans from one or more entities.

In one preferred embodiment, if any claim is in dispute by arbitration or legal proceeding, the instrument is not activated or triggered until resolution of the matter is resolved in favor of the insured.

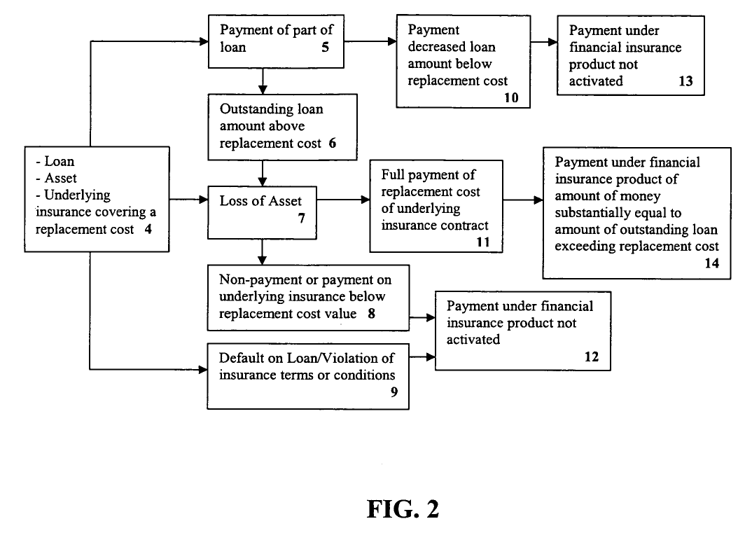

A further understanding of an embodiment of the invention is disclosed in connection with FIG. 2. As indicated in block 4, for the financial insurance product to disburse payment, as indicated in block 14, there must be an asset covered by a basic insurance policy for the asset's replacement cost and an outstanding loan with the asset as collateral. As indicated in block 5, payment in part of the loan by the debtor can occur and thereby reduce the total amount of the loan outstanding. If the total amount of the loan outstanding is reduced below the replacement cost due to partial payment or other reason, as indicated in block 10, there is no loan amount in excess of the replacement cost, and therefore, there would be no payment activated by the financial insurance product as indicated in block 13. However, if the loan still exceeds the replacement cost, as indicated in block 6, then in order for payment to be activated, preferably a total loss of the asset is required 7, and a payment of the replacement cost of the asset by the underlying insurance policy 11 needs to be made. If the loss of the asset and payment of the replacement cost by the underlying insurance company occurs, as indicated in block 7 and 11, respectively, then payment of an amount substantially equal to the portion of the loan exceeding the replacement cost is activated by the financial insurance product as indicated in block 14. In an alternative embodiment, the payment may not exceed the fair market value of the asset. The payment can either first go to the debtor before the outstanding loan is paid off or directly to the lender or to third parties in privity therewith.

Alternatively, there may not be any payments to reduce the loan by the loan holder before a loss occurs, in which case, the requirements of a total loss and payment of the replacement cost by the underlying insurance policy must take place before payment by the insurer will be required by the policy. Furthermore, if after a loss of the asset as indicated in block 7, and if there is non-payment or only partial payment of the replacement cost based on the underlying policy as indicated in block 8, then preferably payment would not be activated by the financial insurance product as indicated in block 12. This is because the financial insurance product of the present invention does not include any drop down clauses and covers only the amount of the outstanding loan in excess of the replacement cost.

Furthermore, in some embodiments, if there is a default or failure to meet the terms and conditions of the underlying insuring instrument, as indicated in block 9, then there would be no payment under the financial insurance product.

In one embodiment, the instrument may be used with respect to commercial real estate transactions. However, in other embodiments, residential real estate may be insured as well. Such properties, both commercial and residential, can involve single properties, multiple properties, individual and joint ownership, as well as a wide variety of other types of ownership or investments. However, assets as commercial or residential real estate are merely exemplary and not limiting for the present invention, as assets may comprise many different types of properties, tangible and intangible.

Furthermore, in other embodiments the insured assets may include boats, machinery or other assets where a loan is made based on the present market value of the asset and the asset is insured by a primary policy based on replacement cost, and where the loan exceeds the replacement cost.

Additionally, in some embodiments, the asset can be a natural resource such as oil, minerals, or coal. Also the asset can be cargo, or any shipment of goods. This would provide additional hedges in the case of loss of an oil tanker, or any ship or vehicle with cargo or goods in transport. Such assets can be retail inventory, or personal property or valuables such as jewelry or heirlooms. Also, an asset can be intangible, for example patents, trademarks or copyrights. Additionally, such an asset can be rights to licensing royalties, or rights to a revenue stream. Such assets can be collateral for any type of capital at risk, such as a loan or bonds, or other financial instruments.

Furthermore, the asset can be a pool or group of assets or properties, or the rents or revenue streams from such pool of properties. Wherein if there is a loss of one property within the pool or group of assets or of the entire pool, the present insurance product can provide payment for a portion or the entire amount of capital at risk above the replacement cost of such property or pool of properties.

The invention having been thus described, it will be apparent to those skilled in the art that the same may be varied in many ways without departing from the spirit of the invention. Any and all such modifications as would be obvious to those skilled in the art are intended to be covered within the scope of the following claims. Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A financial insurance product comprising:
an insurance component covering an amount of capital at risk that exceeds a replacement cost of an asset collateralizing said capital, said insurance component requiring that said asset be insured by at least one separate insurance policy for the replacement cost of said asset; and
a payment component providing payment equal to at least a portion of the amount of capital at risk in excess of said replacement cost upon loss of the asset and subsequent to substantial payment of said replacement cost of said asset by said separate insurance policy.

2. The financial insurance product of claim 1, wherein said payment is an amount substantially equal to said amount of capital at risk in excess of said replacement cost.

3. The financial insurance product of claim 1, wherein said insurance component requires a total loss of said asset.

4. The financial insurance product of claim 1, wherein said capital at risk is at least one loan.

5. The financial insurance product of claim 4, wherein payment is not provided if the at least one loan is defaulted prior to the loss of the asset.

6. The financial insurance product of claim 1, wherein said asset is a group of assets.

7. The financial insurance product of claim 6, wherein said payment component provides payment equal to at least a portion of an amount of capital at risk in excess of said replacement cost of at least one asset within said group of assets upon loss of at least one asset within said group of assets.

8. The financial insurance product of claim 1, wherein said insurance component is a follow form of an underlying basic policy.

9. The financial insurance product of claim 8, wherein said insurance component can include or exclude perils such as mold, lead, terrorism, or demolition accordingly as the basic policy includes or excludes said perils.

10. The financial insurance product of claim 1, wherein providers of said at least one separate insurance policy have a strong credit rating.

11. The financial insurance product of claim 1, wherein said replacement cost is determined using a Marshall Swift Report.

12. The financial insurance product of claim 1, wherein the product is contracted on a basis of five years or less and said product contract is renewable.

13. The financial insurance product of claim 1, wherein said capital at risk is a portion of one or more loans collateralizing said asset;
wherein said one or more loans are those in existence or made at the time of execution of the insurance product or granted subsequent to execution of the insurance product.

14. The financial insurance product of claim 1, wherein a premium is paid for said insurance product, wherein said premium is determined by standard actuarial practices.

15. The financial insurance product of claim 1, wherein said asset is commercial real estate.

16. The financial insurance product of claim 1, wherein said asset is residential real estate.

17. The financial insurance product of claim 1, wherein said asset is industrial equipment.

18. The financial insurance product of claim 1, wherein said asset is retail inventory.

19. The financial insurance product of claim 1, wherein said asset is a natural resource.

20. The financial insurance product of claim 1, wherein said asset is a ship.

21. The financial insurance product of claim 1, wherein said asset is oil.

22. The financial insurance product of claim 1, wherein said asset is intangible property.

23. The financial insurance product of claim 1, wherein said asset is intellectual property.

24. The financial insurance product of claim 1, wherein said asset is rights to a revenue stream.

25. The financial insurance product of claim 1, wherein said asset is a shipment of goods.

26. The financial insurance product of claim 1, wherein said capital at risk is bonds.

27. A financial insurance product comprising:
an insurance component covering only an amount of capital at risk that exceeds a replacement cost of an asset collateralizing said capital; and
a payment component providing payment equal to at least a portion of the amount of capital at risk in excess of said replacement cost upon loss of the asset.

28. The financial insurance product of claim 27, wherein said insurance requires that said asset be insured by at least one separate insurance policy for the replacement cost of said asset.

29. The financial insurance product of claim 28, wherein said payment component provides payment only subsequent to substantial payment of said replacement cost of said asset by said separate insurance policy.

30. The financial insurance product of claim 27, wherein the payment is an amount substantially equal to the amount of capital at risk in excess of said replacement cost.

31. A method of insuring against loss of an amount of capital at risk, comprising:
covering an amount of capital at risk that exceeds a replacement cost of an asset collateralizing said capital, said insurance component requiring that said asset be insured by at least one separate insurance policy for the replacement cost of said asset; and
providing a payment equal to at least a portion of the amount of capital at risk in excess of said replacement cost upon loss of the asset and subsequent to substantial payment of said replacement cost of said asset by said separate insurance policy.

32. The method as set forth in claim 31, further comprising requiring a total loss of said asset.

33. The method as set forth in claim 31, further comprising requiring that said asset be insured under a separate insurance policy covering at least said replacement cost.

34. The method as set forth in claim 32, further comprising providing a payment after substantial payment of said replacement cost of said asset by said separate insurance policy.

35. The method as set forth in claim 31, wherein said replacement cost is determined by a Marshall Swift analysis.

36. The method as set forth in claim 31, wherein said asset is commercial real estate.

37. The method as set forth in claim 31, wherein said asset is residential real estate.

38. The method as set forth in claim 31, wherein said asset is industrial equipment.

39. The method as set forth in claim 31, wherein said asset is retail inventory.

40. The method as set forth in claim 31, wherein said asset is a natural resource.

41. The method as set forth in claim 31, wherein said asset is a ship.

42. The method as set forth in claim 31, wherein said asset is oil.

43. The method as set forth in claim 31, wherein said asset is intangible property.

44. The method as set forth in claim 31, wherein said asset is intellectual property.

45. The method as set forth in claim 31, wherein said asset is rights to a revenue stream.

46. The method as set forth in claim 31, wherein said asset is a shipment of goods.

47. The method as set forth in claim 31, wherein said capital at risk is bonds.

48. The method as set forth in claim 31, wherein said capital at risk is one or more loans.

49. The method as set forth in claim 31, wherein said asset is a group of assets.

50. The method as set forth in of claim 49, comprising providing a payment equal to at least a portion of an amount of capital at risk in excess of said replacement cost of at least one asset within said group of assets upon loss of at least one asset within said group of assets.
